(19) United States
(12) Patent Application Publication
(10) Pub. No.: US 2012/0226780 A1
(43) Pub. Date: Sep. 6, 2012

(54) ENABLING DIGITAL MEDIA CONTENT TO BE DOWNLOADED TO AND USED ON MULTIPLE TYPES OF COMPUTING DEVICE

(75) Inventors: Mark Knight, Surrey (GB); Jaume Vidal, London (GB); Ed Bedwell, London (GB); Duncan Edwards, London (GB); Mark Sullivan, Warwickshire (GB); Michael Lamb, Buckinghamshire (GB)

(73) Assignee: Omnifone Ltd., London (GB)

(21) Appl. No.: 13/263,388

(22) PCT Filed: Apr. 7, 2010
(86) PCT No.: PCT/GB2010/050596

§ 371 Date: May 23, 2012

(30) Foreign Application Priority Data
Apr. 7, 2009 (GB) 0906004.7
Jul. 6, 2009 (GB) 0911661.7

(51) Int. Cl. G06F 15/16

(52) U.S. Cl. 709/219

(57) ABSTRACT

The invention is a method for enabling digital content to be downloaded to and used on multiple types of computing device by (i) linking user accounts on each device to a “master” user account defined and stored on a remote server; and (ii) managing the user's access to a defined service using his devices via the said master user account; and (iii) allowing the download of digital content to each said device on which the user is permitted to access the said service using a file format which is appropriate for use on each said device type. A user may manage and access the same user account from multiple types of computing devices. Furthermore, the number of device platforms accessible in a similar manner by the user is extensible and the user's information is kept automatically synchronized across all devices.

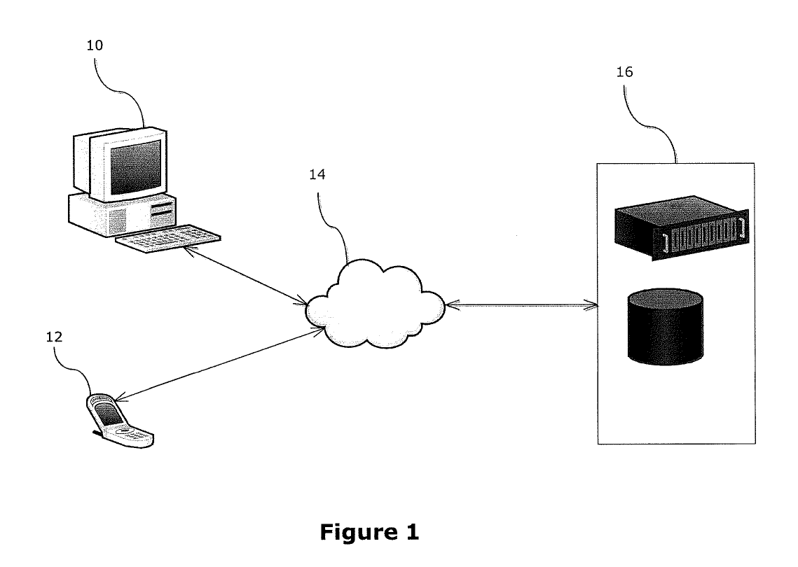

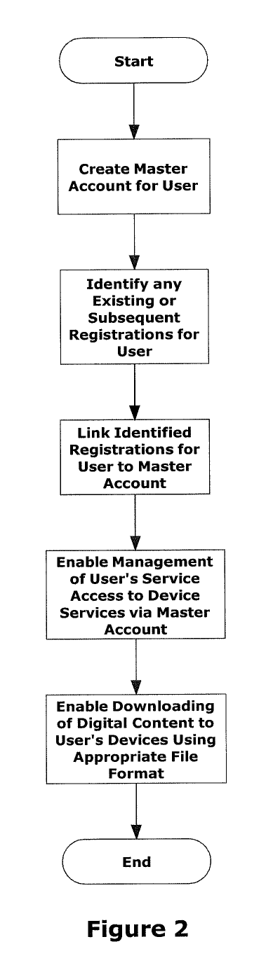

### BACKGROUND OF THE INVENTION

1. Field of the Invention

The present invention is a method for implementing a media player on one or more types of computing device, such that the user of the said devices is able to manage their music and personal information from any associated client device.

2. Description of the Related Art

While it is relatively commonplace for a media player to be usable on a single device, users typically have had to create multiple accounts, one for each device on which they wish to access their digital media files, with limited interoperability between the different accounts on different device platforms.

Uniquely, the present invention provides a method by which the same user account may be managed from both a mobile device and from a personal computer and any other computing device, provided only that the user has obtained access rights on all such devices.

### SUMMARY OF THE INVENTION

The present invention discloses a method by which a user may manage and access the same user account from multiple types of computing devices, including but not limited to mobile devices, personal computers, televisions and gaming consoles, provided only that the user has obtained access rights to each such device. The invention is a method for enabling digital content to be downloaded to and used on multiple types of computing device by (i) linking user accounts on each device to a “master” user account defined and stored on a remote server; and (ii) managing the user's access to a defined service using his devices via the said master user account; and (iii) allowing the download of digital content to each said device on which the user is permitted to access the said service using a file format which is appropriate for use on each said device type.

The master user account may be a consolidation of any individual user accounts, such as per-device user account(s) or any other separate user account(s). Alternatively, the master user account may be used to link any individual user accounts such as per-device user account(s) or any other separate user account(s).

User-specific information may be synchronized across devices such that changes made on one device are visible on the other device(s) via which the user has access to the said service. Furthermore, the number of device platforms accessible in a similar manner by the user is extensible

### 1.1 Definitions

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), computer games and other interactive media, images (photographic or otherwise) and music, music tracks, music albums and releases, eBooks or any other digital media content.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The terms “digital media catalogue”, “digital music catalogue”, “media catalogue” and “catalogue” are used interchangeably to indicate a collection of tracks and/or albums to which a user may be allowed access for listening purposes.

The abbreviation “DRM” is used to refer to a “Digital Rights Management” system or mechanism used to grant access rights to a digital media file.

The verb “to listen” is to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people, whose media content “listening” preferences ate analysed and for whom recommendations are made. In all cases, the masculine includes the feminine and vice versa.

The terms “device” and “media player” are used interchangeably to refer to any computational device which is capable of playing digital media content, including but not limited to MP3 players, television sets, home computer systems, mobile computing devices, games consoles, handheld games consoles, vehicular-based media players or any other applicable device or software media player on such a device.

The “server” or “remote server” is a computing device which takes the role of a server in a client-server architecture.

The “client” device is a computing device and which may be a mobile computing device. The client device may be the same computing device as the server in some configurations.

The “remote database” consists of a collection of data items, however represented, on the server.

The “local database” consists of a collection of data items, however represented, on the client device.

The “network” is a method of communicating between the said server and the said client device using, for example, the internet, a local network, a mobile network a wireless network or any other computing network.

In the preferred embodiment, the database and data items referred to are structured in a relational database which is accessed, directly or indirectly, using Structured Query Language (SQL) or some equivalently powerful Application Programming Interface (API). In the preferred embodiment, the local database is provided via an embedded C database engine. In another embodiment, the client application utilises an external database, whether external to the client application software or external to the client device entirely.

### DETAILED DESCRIPTION

The present invention discloses a method by which a user may manage and access the same user account from multiple types of computing devices, including but not limited to mobile devices, personal computers, televisions and gaming consoles, televisions, DVD players, blu-ray players, in-car media players or any other computing device, provided only that the user has obtained access rights to each such device. Furthermore, the number of device platforms accessible in a similar manner by the user is extensible and the user's information is kept automatically synchronized across all devices.

In the example embodiment described herein, the user's account is kept synchronized between a personal computer and a mobile device. The methods disclosed are transferable to suitable computing devices of any types, provided only that the said device is capable of digital media playback and of being connected via a network to a remote server. Several useful, novel and unique aspects of the user interface of the said personal computer client application are also disclosed in this document.

### 1.2 Unified Account

The first step in creating linked accounts across different devices is to create a single master account for each user. That account is created on the server on first registration of a user via some connected device.

In the preferred embodiment, creation of the said “master” user account requires some uniquely identifying information from the said user. The user's identification may be made using any details defined as uniquely identifying a user, such as a credit or debit card, a confirmed home address, an email address, a device identifier, bank account details or some other mechanism or combination of mechanisms.

In the preferred embodiment, WMDRM over SSL may be employed On some platforms to uniquely identify the user, by way of client specific certificates, that method also being unique to the present invention.

In another example embodiment of the present invention, the “master” account has an associated unique ID which may be used both to identify that account and to link other user accounts to that master account. In still another example embodiment, a combination of the two approaches may be employed.

Having created a single master account for the user, the server then links any pre-existing or subsequently created user registrations by that user to the said master account. The uniquely identifying data described previously is, in the preferred embodiment, utilised to identify any other accounts which are to be linked to the master account.

In one example embodiment, the user's various accounts are maintained separately but are linked to master account, which may be used to manage the user's other user accounts. In the preferred embodiment, the user's other accounts are merged with the master account, which becomes and remains the sole user account for that user.

### 1.3 Device Management

In the preferred embodiment, the user has a single “master” account with the service within which the present invention is utilised. The said master account is then used to manage the user's access to that service on the various devices or groups of devices for which that user has access to the said service.

In the preferred embodiment, the user is able to be granted access to the said service on one or more devices or groups of devices, either independent of one another or collectively. In one example embodiment, the user is granted access to the said service via all supported devices. In another example embodiment, the user is granted access to the said service on a device-by-device basis, such access being managed via the user's master account.

Specifically, given an example embodiment wherein the said service is available via three devices—A, B and C—and selective device access is permitted, perhaps by way of having differing subscription rates for access to the service via different devices, then the user may be granted access to the service on one or more of the said devices and not on the other devices, which may result in the user having access to the said service on devices B and C but not on device A.

In the preferred embodiment, the user is able to manage which devices on which he wishes to access the service via a “device management” tool, such as a webpage which permits the user to define his device access preferences using his master account on the server. In another example embodiment, the user manages his device access in each of his separate user accounts, with each account being linked on the server to a master user account but each account being managed separately and independently by the user. In the latter example embodiment, the user may use a separate user account for each device or device group.

### 1.4 Cross-Device Synchronisation

In the preferred embodiment, the master user account is used to synchronise the user's information across some or all of the devices on which the said user is accessing the said service. This kind of user-specific information can include one or more of the user's name, address, uniquely identifying information, email address, IMEI number, payment details, a list of items which the user has bookmarked as being “favourites”, a list of the user's linked friends, a list of items recommended for or by the user, the user's playlists of digital media files, the user's library of items such as digital media files and any user-entered profile information.

For example, if the user is accessing a digital music subscription service via both a personal computer and a gaming console then in the preferred embodiment the user's profile information, list of linked friends and the user's messaging inbox and list of sent items may be synchronised across both devices such that changes made on one device will appear immediately on the other device when next the devices are connected to the server via a network.

In addition, any other defined sets of information and files which are available on one device would, in the preferred embodiment, be made available to the other device(s) on which the user accesses the said service via similar synchronisation. Details of the synchronisation methodology are disclosed in GB 0921559.1.

In the preferred embodiment within a digital media subscription service, any digital media content downloaded on one device by a user would be made available to any other device(s) for which the said user has access to the said service. The said digital media content is, in the preferred embodiment, made available in a format which is appropriate to the device type on which that content is to be utilised, taking account of device capabilities and—where applicable—DRM (“Digital Rights Management”) schemes available to each device.

1. A method for enabling digital content to be downloaded to and used on multiple types of computing device by (i) linking user accounts on each device to a “master” user account defined and stored on a remote server; and (ii) managing the user's access to a defined service using his devices via the said master user account; and (iii) allowing the download of digital content to each said device on which the user is permitted to access the said service using a file format which is appropriate for use on each said device type.

2. The method of claim 1 where the said master user account is a consolidation of any individual user accounts such as per-device user account(s) or any other separate user account(s).

3. The method of claim 1 where the said master user account is used to link any individual user accounts such as per-device user account(s) or any other separate user account(s).

4. The method of claim 1 where user-specific information is synchronized across devices such that changes made on one device are visible on the other device(s) via which the user has access to the said service.

5. The method of claim 4 where the said user-specific information includes one or more of the user's name, address, uniquely identifying information, email address, IMEI number, payment details, a list of items which the user has bookmarked as being “favourites”, a list of the user's linked friends, a list of items recommended for or by the user, the user's playlists of digital media files, the user's library of items such as digital media files and any user-entered profile information.

6. The method of claim 1 where the said computing device is a personal computer, a gaming console, a mobile device, a television, a DVD player, a Blu-ray player, an in-car media player or any other computing device.

7. The method of claim 1 where the said computing device is connected to the said remote server by a network such as the internet, a mobile network, a wireless network or any other computing network.

8. The method of claim 1 where the said digital content is digital media content, such as music tracks, music albums and releases, video, eBooks, computer games or any other digital media content.

9. The method of claim 1 where the said service is a digital media subscription service.
